(19) United States
(12) Patent Application Publication
(10) Pub. No.: US 2026/0029047 A1
(43) Pub. Date: Jan. 29, 2026

(54) VEHICLE AXLE FOR A TWO-TRACK VEHICLE

(71) Applicant: AUDI AG, Ingolstadt (DE)

(72) Inventors: Stefanie SEIDE, Riedenburg (DE); Klaus TERNOVAN, Gaimersheim (DE); Benjamin AUBER, Schelklingen (DE); Lena SCHLITTENBAUER, Altmannstein (DE); Andrej MERZ, Ingolstadt (DE)

(73) Assignee: AUDI AG, Ingolstadt (DE)

(21) Appl. No.: 19/280,586

(22) Filed: Jul. 25, 2025

(30) Foreign Application Priority Data
Jul. 25, 2024 (DE) 10 2024 121 172.5

(51) Int. Cl. F16H 57/04; F16H 57/02; H02K 7/00; H02K 7/116

(52) U.S. Cl. CPC F16H 57/0424; F16H 57/0483; F16H 2057/02034; H02K 7/006; H02K 7/116

(57) ABSTRACT

A vehicle axle for a two-track vehicle may include a transmission which has an axle differential from output sides of which axle shafts are led to vehicle wheels. For axle-differential lubrication, a lubricant is able to be guided into the housing interior space of a differential housing of the axle differential via at least one housing opening of the differential housing. The axle-differential lubrication may be by way of lubricant ejection of an adjacent rotating transmission component. During the axle-differential lubrication, lubricant drops are able to be cast from the transmission component into the housing interior space of the differential housing through the housing opening of the differential housing under the action of centrifugal force.

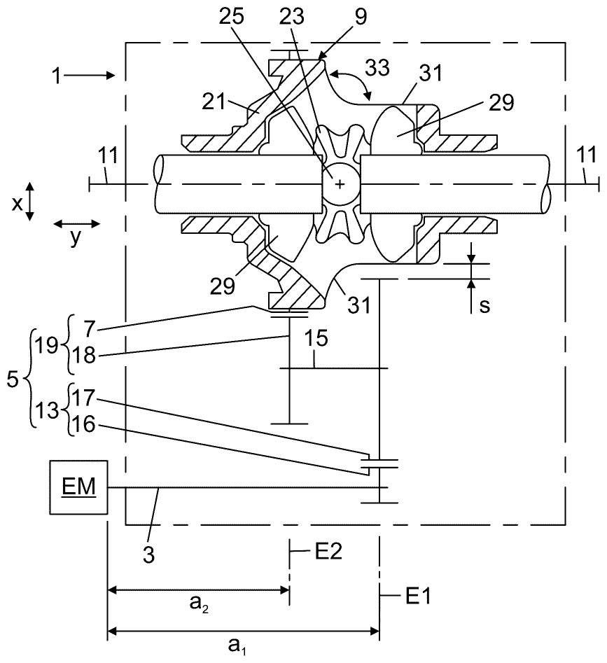

### CROSS-REFERENCE TO RELATED APPLICATIONS

This application claims the priority benefit of German Patent Application No. 10 2024 121 172.5 filed on Jul. 25, 2024, which is incorporated by reference herein in its entirety.

### BACKGROUND

### 1. Field

An invention relates to a vehicle axle for a two-track vehicle, according to described examples including recitations of the present claims.

### 2. Description of the Related Art

Such a vehicle axle can be driven by an electric machine. This outputs drives to an outer gearwheel of a differential housing of an axle differential via a countershaft transmission. Respective axle shafts lead from the output sides of the axle differential to the vehicle wheels of the vehicle axle in the vehicle transverse direction.

In the electrified vehicle axle, the axle differential is normally realized as a bevel-gear differential in order to allow a compensation movement between the vehicle wheels of the vehicle axle when cornering. The bevel gears are mounted in a differential housing and distribute the axle torque between the vehicle wheels.

For this function to be performed, adequate lubrication of the axle-differential components (that is to say bevel gears, pins and possibly thrust washers, etc.) is necessary. In the state of the art, lubrication of the axle differential is normally realized by means of injection lubrication, during which pressurized oil is injected into the housing interior of the differential housing via rails or via a spray nozzle. Alternatively, the lubrication of the axle differential may be realized via splash lubrication or drip lubrication with the aid of special oil-guiding shells.

The provision of such oil-guiding shells, rails or nozzles is associated with high outlay in terms of components and structural space. Injection lubrication is furthermore included in an oil circuit of the vehicle axle. The oil pump of the oil circuit must therefore be of sufficiently large dimensions to ensure the supply of oil during the injection lubrication of the axle differential.

EP 4 246 015 A1 has disclosed a differential transmission for fitting on a vehicle. Lubrication oil is supplied to the interior of the differential housing via an opening section and discharged from it.

US 2015/0276043 A1 has disclosed a motor-vehicle differential with a housing that has a half-housing part. The half-housing has a mechanism for recovering oil sprayed onto the wall and has a mechanism that diverts the recovered oil into the direction of the differential components.

### SUMMARY

The invention according to the examples includes providing a vehicle axle in which axle-differential lubrication with reduced outlay in terms of components and/or structural space in comparison with the prior art is made possible.

An example object may be achieved by the features of the independent claim(s). Refinements of the invention according to the examples may be disclosed in the dependent claims.

The invention according to the examples relates to a vehicle axle for a two-track vehicle, having a transmission which has an axle differential from the output sides of which axle shafts are led to vehicle wheels. For axle-differential lubrication, a lubricant is able to be guided into the housing interior of a differential housing of the axle differential via at least one housing opening thereof. With regard to axle-differential lubrication that is expedient in terms of components and structural space, the following measure may be implemented, such that the axle-differential lubrication is realized by way of lubricant ejection of an adjacent rotating transmission component, during which lubricant drops are cast into the housing interior space of the differential housing through the housing opening thereof under the action of centrifugal force. In this way, the lubricant that is otherwise cast from the transmission component onto the transmission-housing wall is recovered by an expedient procedure and is supplied to the housing interior space of the axle differential without the need for additional components, such as rails or other lubricant-guiding elements. The supply of lubricant to the at least one adjacent transmission component can, by contrast, be realized in a conventional manner, that is to say via splash lubrication, injection lubrication or drip lubrication.

In an industrial realization, the adjacent transmission component may be a gearwheel which rotates axially parallel to the axle shafts. The gearwheel and the housing opening of the differential housing may be situated together in a gearwheel plane that is oriented transversely to the axial direction of the axle shafts. In this case, the housing opening of the differential housing of the axle differential is thus oriented transversely to the axial direction of the axle shafts in alignment with the gearwheel plane.

In an example, the gearwheel may be a constituent part of a countershaft arrangement via which a drive unit, for example, electric machine, is connected in terms of drive to an outer gearwheel formed in a rotationally conjoint manner on the differential housing of the axle differential. The countershaft arrangement may be a double toothing stage or double bevel-gear stage that, when viewed in the axial direction, can be configured to be of axially short construction. In the double toothing stage, the drive shaft may be connected via a first toothing stage to an intermediate shaft, said first toothing stage being constructed from a fixed drive gearwheel arranged on the drive shaft and from a first fixed intermediate-shaft gearwheel arranged on the intermediate shaft, which meshes with said fixed drive gearwheel. Moreover, the intermediate shaft may be connected via a second toothing stage to the differential housing, said second toothing stage being constructed from a second fixed intermediate-shaft gearwheel arranged on the intermediate shaft and from the outer gearwheel of the differential housing of the axle differential, which meshes with said second fixed intermediate-shaft gearwheel. All the shafts of the transmission, that is to say the drive shaft, intermediate shaft and axle shafts, are arranged axially parallel to one another.

In a configuration expedient in terms of structural space of the aforementioned double toothing stage, the first toothing stage may be spaced apart from the electric machine over a first, relatively long axis distance, so as to be remote therefrom. By contrast, the second toothing stage may be spaced apart from the electric machine over a relatively short axis distance, so as to be close thereto. In such a transmission structure, it is simple in terms of construction for the first intermediate shaft gearwheel to be able to be oriented in transverse alignment with the housing opening of the axle differential. Accordingly, the first fixed intermediate-shaft gearwheel of the first toothing stage may readily be arranged adjacent to the housing opening of the differential housing of the axle differential over a lubricant-ejection distance with no interfering contours.

In combination with the transmission structure specified above, the outer gearwheel of the axle differential may be positioned on the differential housing in such a way that an inner corner region is defined between the outer gearwheel and the differential housing. The fixed intermediate-shaft gearwheel of the first toothing stage may project into the inner corner region; moreover, it is also possible for the housing opening to open directly into the inner corner region.

In an example, for realizing the invention, the differential housing is not formed with a housing opening that is to be configured for a purpose of the invention. Instead, a housing opening already present in the differential housing, for example a fitting access for axle-differential components in the housing interior space of the differential housing, may, with a dual function, be used for the supply of lubricant according to the examples of the invention.

### BRIEF DESCRIPTION OF DRAWINGS

Examples of the invention are described below on the basis of the appended FIGURE:

A FIGURE shows a schematic of an electrified vehicle axle of a two-track vehicle according to an example.

### DESCRIPTION

In the FIGURE, an electrified vehicle axle of a two-track vehicle is indicated insofar as is necessary for the understanding of the invention according to the examples. The vehicle axle has, as a drive assembly, an electric machine EM with a transmission 1 via which the electric machine EM outputs drive to the vehicle wheels (not shown). The electric machine EM is connected to an outer gearwheel 7 of an axle differential 9 via a drive shaft 3, with the interposition of a double toothing stage 5. Axle shafts 11 lead from the output sides of said axle differential to the vehicle wheels. In the FIGURE, the electric machine EM is fitted in a transversely installed manner in the vehicle axle. Accordingly, the drive shaft 3, the axle shafts 11 and the intermediate shaft 15 (described later) are positioned axially parallel to one another.

According to the FIGURE, the double toothing stage 5 may include two toothing stages 13, 19. The drive shaft 3 of the electric machine EM is connected via a first toothing stage 13 to an intermediate shaft 15 that is axially parallel thereto. In the FIGURE, the first toothing stage 13 is constructed from a fixed drive gearwheel 16 arranged on the drive shaft 3 and from a first fixed intermediate-shaft gearwheel 17 arranged on the intermediate shaft 15, which meshes with said fixed drive gearwheel 16. The intermediate shaft 15 is connected via a second toothing stage 19 to the outer gearwheel 7 of the axle differential 9. In the FIGURE, the second toothing stage 19 is constructed from a second fixed intermediate-shaft gearwheel 18 arranged on the intermediate shaft 15 and from the outer gearwheel 7 of the axle differential 9, which is attached in a rotationally conjoint manner to the rotating differential housing 21. In the FIGURE, the axle differential 9 outputs drive in the vehicle transverse direction y on both sides, with a 50/50 distribution, to the two axle shafts 11 leading to the vehicle wheels.

In the FIGURE, the first toothing stage 13 is formed in a wheel plane E1 remote from the electric machine, said wheel plane being spaced apart from the electric-machine end face over a distance a₁. By contrast, the second toothing stage 19 is arranged in a wheel plane E2 close to the electric machine, said wheel plane being spaced apart from the electric-machine end face over a shorter distance a₂.

The axle differential 9 is configured as a bevel-gear differential, the transmission construction of which is described below: Accordingly, in the housing interior of the differential housing 21, two differential bevel gears 23 situated oppositely with a spacing so as to be coaxial with one another (of which only one differential bevel gear 23 is shown in the sectional illustration of the FIGURE) are mounted rotatably on a differential pin 25. This is connected in a rotationally conjoint manner to the differential housing 21. Two axle bevel gears 29 situated oppositely with a spacing so as to be coaxial with one another are also mounted rotatably in the housing interior of the differential housing 21. Said axle bevel gears 29 have their axes of rotation oriented perpendicular to the axes of rotation of the two differential bevel gears 23 and are in toothed engagement with the latter. In the FIGURE, the left-hand axle bevel gear 29 is seated on the left-hand axle shaft 11, while the right-hand axle bevel gear 29 is seated on the right-hand axle shaft 11.

The differential housing 21 has two housing openings 31 which are situated axially opposite one another and which form a fitting access for the axle-differential components (23, 25, 29) situated in the housing interior of the differential housing 21.

One essential feature of the invention according to the examples is that the axle-differential lubrication is realized by way of lubricant ejection of the first intermediate-shaft gearwheel 17. During the lubricant ejection, lubricant drops are cast into the housing interior of the differential housing 21 through the housing openings 31 thereof under the action of centrifugal force.

For effective axle-differential lubrication, an inner corner region 33 is defined between the outer gearwheel 7 and the differential housing 21 of the axle differential 9, into which inner corner region the fixed intermediate-shaft gearwheel 17 of the first toothing stage 13 projects. The housing openings 31 of the differential housing 21 open directly into the inner corner region 33. Consequently, the first fixed intermediate-shaft gearwheel 17 is arranged adjacent to the housing openings 31 of the differential housing 21 of the axle differential 9 over a short lubricant-ejection distance s with no interfering contours. In order for lubricant to be applied as fully as possible to the housing interior space, the housing openings 31 of the differential housing 21 are situated together with the fixed intermediate-shaft gearwheel 17 in the wheel plane E1 of the first toothing stage 13.

The supply of lubricant to the further transmission components can, by contrast, be realized via conventional splash lubrication, injection lubrication or drip lubrication.

A description has been provided with particular reference to examples, but it will be understood that variations and modifications can be effected within the spirit and scope of the claims, which may include the phrase “at least one of A, B and C” as an alternative expression that refers to one or more of A, B or C, contrary to the holding in Superguide v. DIRECTV, 358 F3d 870, 69 USPQ2d 1865 (Fed. Cir. 2004).

### LIST OF REFERENCE SIGNS

1 Transmission
3 Drive shaft
5 Double toothing stage
7 Outer gearwheel
9 Axle differential
11 Axle shaft
13 First toothing stage
15 Intermediate shaft
16 Fixed drive gearwheel
17 First fixed intermediate-shaft gearwheel
18 Second fixed intermediate-shaft gearwheel
19 Second toothing stage
21 Differential housing
23 Differential bevel gear
25 Differential pin
29 Axle bevel gear
31 Housing opening
33 Inner corner region
EM Electric machine
a₁, a₂ Distances
S Lubricant-ejection distance
E1, E2 Wheel planes

1. A vehicle axle for a two-track vehicle, comprising:
a transmission including,
a differential housing having a housing interior space and at least one housing opening into the differential housing,
an axle differential situated in the housing interior space, and from output sides of the axle differential, axle shafts are led to vehicle wheels, and
an adjacent rotatable transmission component adjacent to the axle shafts, so that axle-differential lubrication by way of lubricant ejection from the adjacent rotatable transmission component, during which lubricant ejection, drops of a lubricant are able to be guided and cast from the adjacent rotatable transmission component into the housing interior space of the differential housing through the at least one housing opening of the differential housing under centrifugal force provided by the adjacent rotatable transmission component.

2. The vehicle axle according to claim 1, wherein the adjacent rotatable transmission component is a gearwheel which is configured to rotate axially parallel to the axle shafts, and the gearwheel and the at least one housing opening of the differential housing are situated together in a gearwheel plane (E1) oriented transversely to an axial direction of the axle shafts.

3. The vehicle axle according to claim 2, wherein the at least one housing opening of the differential housing of the axle differential is oriented transversely to the axial direction of the axle shafts in alignment with the gearwheel plane (E1).

4. The vehicle axle according to claim 2, wherein the gearwheel is a constituent part of a countershaft arrangement via which a drive unit configured as an electric machine (EM), is connected in terms of drive to an outer gearwheel formed in a rotationally conjoint manner on the differential housing of the axle differential.

5. The vehicle axle according to claim 4, wherein
the countershaft arrangement is a double toothing stage in which a drive shaft of the EM is connected via a first toothing stage to an intermediate shaft,
the first toothing stage being constructed from a fixed drive gearwheel arranged on the drive shaft and from a first fixed intermediate-shaft gearwheel arranged on the intermediate shaft, which meshes with the fixed drive gearwheel, and in which the intermediate shaft is connected via a second toothing stage to the differential housing,
the second toothing stage being constructed from a second fixed intermediate-shaft gearwheel arranged on the intermediate shaft and from the outer gearwheel of the differential housing of the axle differential, which meshes with said second fixed intermediate-shaft gearwheel, and
the drive shaft, the axle shafts and the intermediate shaft of the transmission are arranged axially parallel to one another.

6. The vehicle axle according to claim 5, wherein the first toothing stage is spaced apart from the EM over a distance (a₁) so as to be remote from the EM, and the second toothing stage is spaced apart from the EM over a distance (a₂) so as be closer to the EM than the first toothing stage.

7. The vehicle axle according to claim 5, wherein the first fixed intermediate-shaft gearwheel of the first toothing stage, is spaced apart from the at least one housing opening of the differential housing of the axle differential over a lubricant-ejection distance(s) with no interfering contours.

8. The vehicle axle according to claim 5, wherein
the outer gearwheel and the differential housing of the axle differential define an inner corner region, into which inner corner region the first fixed intermediate-shaft gearwheel of the first toothing stage projects, and the at least one housing opening opens into the inner corner region.

9. The vehicle axle according to claim 1, wherein the at least one housing opening additionally forms a fitting access via which axle-differential components of the axle differential are able to be fitted in the housing interior space of the differential housing.

10. The vehicle axle according to claim 1, a supply of the lubricant to the adjacent rotatable transmission component is via at least one lubrication supply provision from among lubrication supply provisions including splash lubrication, injection lubrication, or drip lubrication.
